(19) United States
(12) Patent Application Publication
(10) Pub. No.: US 2026/0313498 A1
(43) Pub. Date: Oct. 8, 2026

(54) METHOD AND APPARATUS FOR MANAGING MOBILITY OF UE

(71) Applicant: Samsung Electronics Co., Ltd., Gyeonggi-do (KR)

(72) Inventor: Aby Kanneath ABRAHAM, Bangalore (KR)

(21) Appl. No.: 19/482,627

(22) PCT Filed: May 9, 2024
(86) PCT No.: PCT/KR2024/006248

§ 371 Date: Nov. 7, 2025

(30) Foreign Application Priority Data
May 9, 2023 (IN) 202341032762
Apr. 26, 2024 (IN) 202341032762

(51) Int. Cl. H04W 36/08

(52) U.S. Cl. CPC H04W 36/08

(57) ABSTRACT

The disclosure relates to a 5G or 6G communication system for supporting a higher data transmission rate. A method for managing mobility by a user equipment (UE) in a wireless network is provided. The method may comprise: identifying whether the UE is configured with configuration to report successful primary secondary cell group (SCG) cell (PSCell) change or addition information to a network, when performing a PSCell change; and in case that the UE is configured with the configuration to report the successful PSCell change or addition information to the network, releasing the configuration to report the successful PSCell change or addition information to the network based on the successful PSCell change.

### TECHNICAL FIELD

Embodiments disclosed herein relate to wireless communication networks, and more particularly to managing multi-radio dual connectivity in wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

The principal object of the embodiments herein is to disclose methods and systems for managing mobility.

A yet another object of the embodiments disclosed herein is to disclose methods and systems for performing and optimizing mobility by successful PSCell change report and Successful PSCell addition report, SCG Failure and the optimization scenarios for both SCG L3 mobility and SCG LTM.

A yet another object of the embodiments disclosed herein is to disclose methods and systems for managing mobility by LTM for PSCellChange, configured by either the SN or the MN.

Another object of the embodiments herein is to disclose UE behavior with LTM for deactivated SCG and SCells.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

According to an embodiment of the present disclosure, a method for managing mobility by a user equipment (UE) in a wireless network is provided. The method may comprise transmitting, to a network apparatus, at least one of a first capability of the UE for performing lower-layer triggered mobility (LTM) for a master cell group (MCG) and a second capability of the UE for performing LTM for a secondary cell group (SCG); receiving a signaling message including a successful primary SCG secondary cell group cell (PSCell) change or addition report (SPR) configuration of at least one of a source PSCell and a target PSCell from the network apparatus; determining whether at least one condition related to SPR for LTM is met based on the SPR configuration; logging the SPR for the LTM, when the at least one condition related to SPR for the LTM is met; and transmitting the logged SPR to the network apparatus upon receiving a request to report the SPR.

According to an embodiment of the present disclosure, a user equipment (UE) for managing mobility in a wireless communication system is provided. The UE may comprise a transceiver; and at least one processor coupled with the transceiver. The at least one processor may be configured to transmit, to a network apparatus, at least one of a first capability of the UE for performing lower-layer triggered mobility (LTM) for a master cell group (MCG) and a second capability of the UE for performing LTM for a secondary cell group (SCG), receive a signaling message including a successful primary SCG secondary cell group cell (PSCell) change or addition report (SPR) configuration of at least one of a source PSCell and a target PSCell from the network apparatus, determine whether at least one condition related to SPR for LTM is met based on the SPR configuration, log the SPR for the LTM, when the at least one condition related to SPR for the LTM is met, and transmit the logged SPR to the network apparatus upon receiving a request to report the SPR.

According to an embodiment of the present disclosure, a network apparatus for managing mobility of a user equipment (UE) in a wireless communication system is provided. The network apparatus may comprise a transceiver; and at least one processor coupled with the transceiver. The at least one processor may be configured to receive, from the UE, at least one of a first capability of the UE for performing lower-layer triggered mobility (LTM) for a master cell group (MCG) and a second capability of the UE for performing LTM for a secondary cell group (SCG), transmit, to the UE, a signalling message including a successful primary SCG secondary cell group cell (PSCell) change or addition report (SPR) configuration of at least one of a source PSCell and a target PSCell in a signalling message, transmit, to the UE, a request for reporting a logged information of SPR for LTM, and receive, a report for the SPR for the LTM upon receiving a request to report the logged information, based on at least one conditions related to the SPR for the LTM being met based on the SPR configuration.

According to an embodiment of the present disclosure, a method for managing mobility by a user equipment (UE) in a wireless network is provided. The method may comprise identifying whether the UE is configured with configuration to report successful primary secondary cell group (SCG) cell (PSCell) change or addition information to a network, when performing a PSCell change; and in case that the UE is configured with the configuration to report the successful PSCell change or addition information to the network, releasing the configuration to report the successful PSCell change or addition information to the network based on the successful PSCell change.

According to an embodiment of the present disclosure, a method for managing mobility by a user equipment (UE) in a wireless network is provided. The method may comprise identifying an indication by lower layers that a procedure for a lower-layer triggered mobility (LTM) cell switch is triggered; identifying whether the LTM cell switch is triggered on a master cell group (MCG) or on a secondary cell group (SCG); and releasing or clearing current dedicated radio configuration associated with a cell group for which the procedure for the LTM cell switch is triggered based on the identified indication and whether the LTM cell switch is on the MCG or on the SCG. Releasing or clearing the current dedicated radio configuration may comprise if the LTM cell switch is triggered on the MCG, releasing or clearing the current dedicated radio configuration associated with the cell group for which the procedure for the LTM cell switch except for first at least one parameter including an MGC cell-radio network temporary identifier (C-RNTI) and access stratum (AS) security configurations associated with a master key.

According to an embodiment of the present disclosure, a m user equipment (UE) for managing mobility in a wireless network is provided. The UE may comprise a transceiver; and at least one processor coupled with the transceiver. The at least one processor may be configured to identify whether the UE is configured with configuration to report successful primary secondary cell group (SCG) cell (PSCell) change or addition information to a network, when performing a PSCell change; and in case that the UE is configured with the configuration to report the successful PSCell change or addition information to the network, release the configuration to report the successful PSCell change or addition information to the network based on the successful PSCell change.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 shows a block diagram of the wireless communication system, according to embodiments as disclosed herein;

FIG. 2A shows a flowchart for a method for managing LTM in a wireless communication network, according to embodiments as disclosed herein;

FIG. 2B shows a flowchart for a method for managing LTM in a wireless communication network, according to embodiments as disclosed herein;

FIG. 3 depicts the process of performing random access for early TA on deactivated SCG, according to embodiments as disclosed herein;

FIG. 4 depicts the process of performing LTM measurements on a deactivated SCG, according to embodiments as disclosed herein;

FIG. 5 depicts the process of performing random access for early TA on a deactivated SCell, according to embodiments as disclosed herein;

FIG. 6 depicts the process of performing LTM measurements on deactivated Scells, according to embodiments as disclosed herein; and

FIG. 7 depicts the process of handling SPR and LTM, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

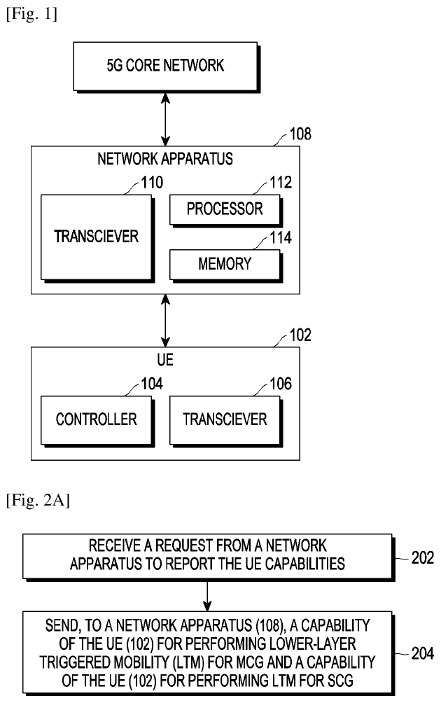

The embodiments herein achieve disclose methods and systems for optimizing performing and optimizing mobility. Referring now to the drawings, and more particularly to FIGS. 1 through 5, where similar reference characters denote corresponding features consistently throughout the figures, there are shown at least one embodiment.

Dual connectivity or more technically multi-radio dual connectivity is specified by 3GPP in specifications such as TS 37.340.

Next Generation Radio Access Network (NG-RAN) supports Multi-Radio Dual Connectivity (MR-DC) operation whereby a user equipment (UE) in RRC_CONNECTED is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node act as the master node (MN) and the other as the secondary node (SN). The MN and SN are connected via a network interface and at least the MN is connected to the core network. NG-RAN supports NG-RAN E-UTRA-NR Dual Connectivity (NGEN-DC), in which a UE is connected to one ng-eNB (an E-UTRA base station that can connect to 5G core) that acts as a MN and one gNB (5G base station) that acts as a SN. NG-RAN also supports NR-E-UTRA Dual Connectivity (NE-DC), in which a UE is connected to one gNB that acts as a MN and one ng-eNB that acts as a SN. The MN may move a secondary cell group (SCG) to an activated state, or a deactivated state. When carrier aggregation is supported, the secondary cells may be moved to deactivated or activated states. When a radio link failure occurs in the SCG, the UE sends RRC message SCGFailureInformation.

A PSCell change can occur due to mobility and may or may not be associated with the Secondary Node Change (SN change). The Secondary Node Change procedure can be initiated either by the MN or the SN and used to transfer a UE context from a source SN to a target SN and to change the SCG configuration in the UE from one SN to another.

A Conditional PSCell Change (CPC) is defined as a PSCell change that is executed by the UE when execution condition(s) is met. The UE may be configured with an execution condition and the RRC message like RRC Reconfiguration for executing when the conditions are met for one or more of candidate cells. The UE starts evaluating the execution condition(s) upon receiving the conditional PSCell change (CPC) configuration, and stops evaluating the execution condition(s) once PSCell change has been triggered. Intra-SN CPC without MN involvement, inter-SN CPC initiated either by MN or SN are supported.

In an aspect herein, following are principles followed by CPC:
The CPC configuration contains the configuration of CPC candidate PSCell(s) and execution condition(s) and may contain the MN configuration for inter-SN CPC.
An execution condition may include of one or two trigger condition(s) (CPC events A3/A5, as defined in TS 38.331). Only single RS type is supported and at most two different trigger quantities (e.g., RSRP and RSRQ, RSRP and SINR, etc.). The single RS type can be configured simultaneously for the evaluation of CPC execution condition of a single candidate PSCell.
Before any CPC execution condition is satisfied, upon reception of PSCell change command or PCell change command, the UE executes the PSCell change procedure as described in clause 10.3 and 10.5 or the PCell change procedure as described in clause 9.2.3.2 in TS 38.300 or clause 10.1.2.1 in TS 36.300, regardless of any previously received CPC configuration.

Upon the successful completion of PSCell change procedure or PCell change procedure, the UE releases all stored CPC configurations. While executing CPC, the UE is not required to continue evaluating the execution condition of another candidate PSCell(s). Once the CPC procedure is executed successfully, the UE releases all stored CPC configurations. Upon the release of SCG, the UE releases the stored CPC configurations.

3GPP release 18 enhances the CPC through selective activation of cell groups where the UE does not release the stored CPC configuration for one or more candidate PSCells and the source PSCell based on network's inputs. The UE may also store the CPA configuration for one or more candidate PSCells.

The MN adds PSCell during a PSCell addition procedure. A PSCell addition procedure that is executed only when then PSCell addition condition(s) are met is called Conditional PSCell Addition (CPA). 3GPP TS 37.340, TS 38.331, TS 38.300 serve as a background.

Self-Optimization in NR: A 5G NR (new radio) radio access network apparatus (108) also known as NG-RAN (Next Generation Radio Network) comprises of a number of NR base stations knows as gNBs. gNBs can be connected to each other through a Xn interface, and may be connected to various core network elements like AMF (Access and Mobility Management Function), UPF (User Plane Function) etc. Further, the gNBs can be divided into two physical entities named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control). The DU provides support for the lower layers of the protocol stack such as RLC (Radio Link Control), MAC (Medium Access Control) and Physical layer. Each gNB can have multiple cells serving many UEs (User Equipment). There are a large number of algorithms and configuration parameters used in NG-RAN. Especially, it is a very difficult task to identify the most optimal radio parameters and operators used to resort to manual techniques like drive tests to identify the optimal parameters. However, such manual parameter tuning is a costly operation, since it depends on a lot of factors like the number of users, number of neighbors, maximum throughput in the cell, average throughput in the cell etc. Further, whenever a neighbor gNB is installed or a new service is introduced, many of these manual operations need to be repeated. To resolve this problem, 3GPP has introduced Self-Organizing Networks (SON) techniques in the wireless technologies like NR. SON was first introduced in 3gpp release 9, in LTE. SON solutions can be divided into three categories: Self-Configuration, Self-Optimization and Self-Healing. The SON architecture can be a centralized, distributed or a hybrid solution. Mobility Robustness Optimization (MRO) is a SON technique which is used to optimize various parameters related to mobility.

According to 3gpp specifications like TS 38.300 V17.3.0, mobility robustness optimization (MRO) aims at detecting and enabling correction of following problems: i) connection failure due to intra-system or inter-system mobility; ii) Inter-system unnecessary handover (HO) (too early inter-system HO from NR to E-UTRAN with no radio link failure); Inter-system HO ping-pong.

The MRO provides means to distinguish the above problems from NR coverage related problems and other problems, however the means or the solution is not related to mobility.

One of the functions of Mobility Robustness Optimization is to detect a sub-optimal successful PSCell change or sub-optimal successful PSCell addition event.

A sample configuration is given below:

| | |
|---|---|
| SuccessPAC-Config-r17 ::= | SEQUENCE { |
| thresholdPercentageT304-r17 | ENUMERATED {p40, p60, p80, spare5, spare4, |

spare3, spare2, spare1} OPTIONAL, -- Need R

| | |
|---|---|
| thresholdPercentageT310-r17 | ENUMERATED {p40, p60, p80, spare5, spare4, |

spare3, spare2, spare1} OPTIONAL, -- Need R

| | |
|---|---|
| thresholdPercentageT312-r17 | ENUMERATED {p20, p40, p60, p80, spare4, spare3, |

spare2, spare1} OPTIONAL, -- Need R
...
}

The Network (for e.g., gNB in NR) configures the UE to log and report Successful PSCell Change or Addition Report (SPR) through IE otherConfig in RRC Reconfiguration. The SPR configuration can include one or more of different triggering conditions such as
i) T310 trigger: The T310 trigger (i.e., threshold) (for e.g., thresholdPercentageT310) will be configured by the source PSCell. Alternatively, the T310 trigger may be configured by the PCell. The Source PSCell or PCell will configure the T310 trigger in the configuration for SPR for reporting successful PSCell Change information and not in the configuration for reporting successful PSCell Addition information.
ii) T312 trigger: T312 trigger (i.e., threshold) (for e.g., thresholdPercentageT312) will be configured by the source PSCell. Alternatively, the T312 trigger may be configured by the PCell. The Source PSCell or PCell will configure the T312 trigger in the configuration for reporting successful PSCell Change information and not in the configuration for reporting successful PSCell Addition information.
iii) T304 trigger: The T304 trigger (i.e., threshold) (for e.g., thresholdPercentageT304) will be configured by the target PSCell. Alternatively, the T304 trigger may be configured by the PCell. The Target PSCell/PCell configures the T304 trigger in the configuration for reporting successful PSCell Change information and in the configuration for reporting successful PSCell Addition information, if the UE is configured to perform random access after PSCell addition.

In the current systems, SPR contents may be as below:
Cell Radio Network Temporary Identifier (c-RNTI): This field indicates the C-RNTI assigned by the target PSCell of the PSCell Addition or PSCell Change for which the successful PAC report (successful PACreport stores SPR) was generated.
measResultListNR: This field refers to the last measurement results taken in the neighboring NR Cells when a successful PSCell Addition or PSCell Change is executed.
Spr-Cause: This field is used to indicate the cause of the successful PSCell report. sourceCellMeas: This field refers to the last measurement results taken in the source PSCell of a PSCellChange in which the successful PSCell Change trigger SPR.
sourcePSCellId: This field is used to indicate the source PSCell of a PSCell change in which the successful PSCell change triggers the SuccessPAC-Report.
targetPSCellId: This field is used to indicate the target PSCell of a PSCellChange in which the successful PSCell change or the PSCell where successful PSCell Addition triggers the SuccessPAC-Report
targetCellMeas: This field refers to the last measurement results taken in the target PSCell of a PSCell change or PSCell Addition in which the successful PSCell change or successful PSCell Addition triggers the SuccessPAC-Report
timeSinceCPAC-Reconfig: This field is used to indicate the time elapsed between the initiation of the last conditional PSCell addition or PSCell change execution towards the target cell and the reception of the latest conditional reconfiguration for this target cell. Actual value=field value*100 ms. The maximum value 1023 means 102.3s or longer.

Mobility in NR: In wireless technologies like 5G NR, the devices can move across different cells. Mobility can be performed using a procedure called cell reselection in RRC_IDLE mode.

Till NR R17, mobility is performed using a procedure called handover in RRC_CONNECTED mode. Network controlled mobility applies to UEs in RRC_CONNECTED. It requires explicit RRC signalling to be triggered by the gNB in NR. Handover in NR usually comprises of three steps: handover preparation, handover execution and handover completion. The gNB may configure the UE to report measurements and based on the reported measurements or based on its own understanding of the network topology, the gNB will send RRC Reconfiguration message to handover the UE to another cell called target cell from the source cell. The UE accesses the target cell and sends RRC Reconfiguration complete message. In an alternative way introduced in 3gpp NR release 16, the gNB may configure the UE with the execution conditions for triggering handover and once the execution conditions are satisfied, the UE may move to target cell and sends the RRC Reconfiguration complete. In all these methods, the UE performs handover by sending layer 3 (RRC) messages which causes considerable signalling overhead and latency issues. During handover, the UE may be configured to apply full configuration during a L3 handover, and if configured, the UE applies full configuration as described in section 5.3.5.11 of TS 38.331. Embodiments herein refer to the handover, and conditional handover (CHO) as layer 3 mobility. In case of dual connectivity, the UE may perform PSCellChange or Conditional PSCellChange. In the context of dual connectivity, embodiments herein refer to PSCellChange or Conditional PSCellChange also as layer 3 mobility; i.e., Handover, Conditional Handover, PSCellChange, Conditional PSCellChange etc. refers to L3 mobility. Embodiments herein also refer to PSCellChange or Conditional PSCellChange as SCG layer 3 mobility and the handover and CHO as MCG layer 3 mobility in the context of dual connectivity.

3gpp specifications such as TS38.300, TS38.331, TS 38.321 can also be considered as relevant background.

3gpp release 18 is considering Lower layers (L1/L2 layers) Triggered Mobility, also known as LTM to solve this problem. As per 3gpp, the goal of LTM is to enable a serving cell change via L1/L2 signalling, in order to reduce the latency, overhead and interruption time. The Network (gNB) may configure the UE with multiple candidate cells to allow fast application of configurations for candidate cells. The Network may further send MAC CE or L1 signalling (using cell switch command) to dynamically switch the UE from a source cell to one of the configured candidate cells. Further, LTM can be triggered based on L1 measurements rather than L3 measurements. The UE may receive LTM measurement configuration from the gNB, which are L1 measurement configuration which tells the UE what to measure, how to report, what to report etc. The LTM measurement object informs the UE what to measure for LTM.

3gpp proposes to perform LTM, without reset of lower layers like MAC to avoid data loss and to reduce the additional delay of data recovery, wherever it is possible. The gNB may provide LTMCandidateConfiguration; i.e., configure LTM candidate cells through one RRCReconfiguration message for a candidate target cell or through one CellGroupConfig for each candidate target cell or through any similar RRC structure or IE containing the similar fields (for e.g., a new IE LTM-CandidateConfig can be defined as ASN.1 sequence containing cellgroupconfig and some other information elements in the RRCReconfiguration). The gNB may further release or modify the candidate configurations. A UE may store the LTM configuration of other candidate cells even after moving to a candidate cell through LTM.

To avoid transmitting a large message over air interface, the gNB can provide the LTMCandidateConfiguration as delta configuration instead of full configuration. The gNB can indicate the UE to use the source cell configuration as the reference for delta configuration or provide the reference configuration explicitly.

The gNB may provide LTMCandidateConfiguration; i.e., configure LTM candidate cells through one RRCReconfiguration message for a candidate target cell or through one CellGroupConfig for each candidate target cell or through any similar RRC structure or IE containing the similar fields (for e.g., a new IE LTM-CandidateConfig can be defined as ASN.1 sequence containing CellGroupConfig and some other information elements in the RRCReconfiguration). The gNB may further release or modify the candidate configurations. A UE may store the LTM configuration of other candidate cells even after moving to a candidate cell through LTM. The gNB also may provide the UE with configuration for performing LTM measurements for different candidate frequencies and candidate cells and reporting based on the performed LTM measurements.

An example sequence is given as below:

ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-Ies, |
| criticalExtensionsFuture | SEQUENCE { } |

}
}

| | |
|---|---|
| RRCReconfiguration-Ies ::= | SEQUENCE { |
| radioBearerConfig | RadioBearerConfig |

OPTIONAL, -- Need M

| | |
|---|---|
| secondaryCellGroup | OCTET STRING (CONTAINING CellGroupConfig) |

OPTIONAL, -- Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-Ies |

OPTIONAL
}

| | |
|---|---|
| RRCReconfiguration-v1530-Ies ::= | SEQUENCE { |

| | |
|---|---|
| masterCellGroup | OCTET STRING (CONTAINING CellGroupConfig) |

OPTIONAL, -- Need M

| | |
|---|---|
| fullConfig | ENUMERATED {true} |

OPTIONAL, -- Cond FullConfig

| | |
|---|---|
| dedicatedNAS-MessageList | SEQUENCE (SIZE(1..maxDRB)) OF |

| | |
|---|---|
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |

| | |
|---|---|
| System Information) | OPTIONAL, -- Need N |
| otherConfig | OtherConfig |

OPTIONAL, -- Need M

| | |
|---|---|
| nonCriticalExtension | RRCReconfiguration-v1540-Ies |

```
  OPTIONAL
  }
```

| | |
|---|---|
| RRCReconfiguration-v1540-Ies ::= | SEQUENCE { |

| | |
|---|---|
| otherConfig-v1540 | OtherConfig-v1540 |

OPTIONAL, -- Need M

| | |
|---|---|
| nonCriticalExtension | RRCReconfiguration-v1560-Ies |

```
  OPTIONAL
  }
```

| | |
|---|---|
| RRCReconfiguration-v1560-Ies ::= | SEQUENCE { |
| mrdc-SecondaryCellGroupConfig | SetupRelease { MRDC- |
| SecondaryCellGroupConfig } | OPTIONAL, -- Need M |

| | |
|---|---|
| radioBearerConfig2 | OCTET STRING (CONTAINING RadioBearerConfig) |

OPTIONAL, -- Need M

| | |
|---|---|
| sk-Counter | SK-Counter |

OPTIONAL, -- Need N

| | |
|---|---|
| nonCriticalExtension | RRCReconfiguration-v1610-Ies |

```
  OPTIONAL
  }
```

| | |
|---|---|
| RRCReconfiguration-v1610-Ies ::= | SEQUENCE { |

| | |
|---|---|
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING |
| PosSystemInformation-r16-Ies) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA- |

Info-r16} OPTIONAL, -- Need M

| | |
|---|---|
| targetCellSMTC-SCG-r16 | SSB-MTC |

OPTIONAL, -- Need S

| | |
|---|---|
| nonCriticalExtension | RRCReconfiguration-v1700-Ies |

```
  OPTIONAL
  }
```

| | |
|---|---|
| RRCReconfiguration-v1700-Ies ::= | SEQUENCE { |

| | |
|---|---|
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 } |

OPTIONAL, -- Need M

| | |
|---|---|
| sl-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

r17} OPTIONAL, -- Need M

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL- |

| | |
|---|---|
| TDOA-Config-r17} | OPTIONAL, -- Need M |
| nonCriticalExtension | RRCReconfiguration-v18xy |

```
  OPTIONAL
  }
```

| | |
|---|---|
| RRCReconfiguration-v18xy-Ies ::= | SEQUENCE { |
| ltm-CandidateConfig-r18 | SetupRelease {LTM-CandidateConfig-r18} |

OPTIONAL, -- Need M

| | |
|---|---|
| nonCriticalExtension | SEQUENCE { } |

```
  OPTIONAL
  }
```

The following elements show Radio resource control information elements:

LTM-CandidateConfig: The IE LTM-CandidateConfig is used to provide LTM candidate cell configuration. If the UE receives RRC Reconfiguration including LTM candidate configuration, the UE performs LTM configuration. An example sequence for LTM candidate configuration executed by the UE is given below (in the baseline CR for TS 38.331):

An example LTM configuration and execution:

### General

The UE shall perform the following actions based on a received LTM-CandidateConfig IE:
store the received ltm-ReferenceConfiguration in VarLTM-Config, if present;
1> if the LTM-CandidateConfig includes the ltm-CandidateToReleaseList:
2> perform the LTM candidate cell release as specified in Step 2;
1> if the LTM-CandidateConfig includes the ltm-CandidateResetL2-List:
2> add the received ltm-CandidateResetL2-List to VarLTM-Config;
1> if the LTM-CandidateConfig includes the ltm-CandidateToAddModList:
2> perform the LTM candidate cell addition or reconfiguration as specified in Step 3;
1> perform the actions to generate a complete LTM configuration as specified in step 4;

It depends on the UE implementation to postpone the generation of a complete LTM configuration until the executing of an LTM cell switch.

### Step 2: LTM Candidate Cell Release

The UE shall:
1> for each ltm-CandidateId in the ltm-CandidateToReleaseList:
2> if the current VarLTM-Config includes an ltm-Candidate with the given ltm-CandidateId:
3> release the ltm-Candidate from VarLTM-Config;

### Step 3 LTM Candidate Cell Addition/Modification

The UE shall:
1> for each ltm-CandidateId in the ltm-CandidateToAddModList:
2> if the current VarLTM-Config includes an ltm-Candidate with the given ltm-CandidateId:
3> modify the ltm-Candidate within VarLTM-Config in accordance with the received ltm-Candidate;
2> else:
3> add the received ltm-Candidate to VarLTM-Config.

### Step 4 Generation of UE LTM Configuration

The purpose of generation of UE LTM configuration procedure is for the UE to generate a complete LTM candidate cell configuration to be stored and applied only when an indication of an LTM cell switch is received by lower layers. During the generation of a complete LTM candidate cell configuration, the current UE configuration shall not be modified.

The UE shall:
1> for each ltm-Candidate in ltm-CandidateConfigList within VarLTM-Config;
2> store the ltm-CandidateId included in ltm-Candidate within VarLTM-UE-Config;
2> if ltm-Candidate includes ltm-ConfigComplete;
3> generate a complete LTM candidate cell configuration for the received ltm-Candidate according to the actions described in clause 5.3.5.3 and store it in UE-LTM-Config within VarLTM-UE-Config.
2> else:
3> generate a complete LTM candidate cell configuration by applying ltm-Candidate on top of referenceConfiguration according to the actions described in clause 5.3.5.3 and store it in UE-LTM-Config within VarLTM-UE-Config.

### Step 5 LTM Cell Switch Execution

Upon the indication by lower layers that an LTM cell switch procedure is triggered, the UE shall:
1> release/clear all current dedicated radio configuration except for the following:
2> if the LTM cell switch is triggered on the MCG:
   the MCG C-RNTI;
   the AS security configurations associated with the master key;
2> else, if the LTM cell switch is triggered on the SCG:
   the SCG C-RNTI;
   the AS security configurations associated with the secondary key;
   the SRB1/SRB2 configurations and DRB configurations as configured by radioBearerConfig or radioBearerConfig2;
   the UE variables VarLTM-Config and VarLTM-UE-Config.
1> release/clear all current common radio configuration;
1> use the default values specified in 9.2.3 for timers T310, T311 and constants N310, N311;
1> apply the default L1 parameter values as specified in corresponding physical layer specifications except for the following:
   parameters for which values are provided in SIB1;
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation as specified in TS 38.323, and with the same security configuration as the PDCP entity for the source cell group;
1> stop timer T310 for the corresponding SpCell, if running;
1> if this procedure is executed for the MCG:
2> if timer T316 is running;
3> stop timer T316;
1> stop timer T312 for the corresponding SpCell, if running;
apply the specified BCCH configuration defined in 9.1.1.1 for the target LTM candidate cell configuration;
1> acquire the MIB of the target SpCell as indicated in the LTM candidate cell configuration indicated by lower layers, which is scheduled as specified in TS 38.213 [13], if applicable;
1> apply the LTM configuration in UE-LTM-Config within VarLTM-UE-Config related to the LTM candidate cell configuration identity as received by lower layers.
1> submit the RRCReconfigurationComplete message to lower layers for transmission using the new configuration.

| | |
|---|---|
| RRCReconfiguration-v1700-Ies ::= | SEQUENCE { |

| | |
|---|---|
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 } |

OPTIONAL, -- Need M

| | |
|---|---|
| sl-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

r17} OPTIONAL, -- Need M

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL- |

| | |
|---|---|
| TDOA-Config-r17} | OPTIONAL, -- Need M |
| nonCriticalExtension | RRCReconfiguration-v18xy |

OPTIONAL
}

| | |
|---|---|
| RRCReconfiguration-v18xy-Ies ::= | SEQUENCE { |
| ltm-CandidateConfig-r18 | SetupRelease {LTM-CandidateConfig-r18} |

OPTIONAL, -- Need M

| | |
|---|---|
| nonCriticalExtension | SEQUENCE { } |

OPTIONAL
}

### Ltm-CandidateConfig:

Configuration of LTM candidate cell(s), reference configuration for LTM cell(s) and sets of cells in which full L2 reset is applied upon an LTM cell switch.

### Serving Cell Specific MAC and PHY Parameters for a SpCell:

| SpCellConfig ::= | SEQUENCE { | |
|---|---|---|
| servCellIndex | ServCellIndex | OPTIONAL, -- |

Cond SCG

| | |
|---|---|
| reconfigurationWithSync | ReconfigurationWithSync |

OPTIONAL, -- Cond ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | | |
|---|---|---|
| spCellConfigDedicated | ServingCellConfig | OPTIONAL, |

```
-- Need M
  ...,
  [[
```

| | |
|---|---|
| lowMobilityEvaluationConnected-r17 | SEQUENCE { |
| s-SearchDeltaP-Connected-r17 | ENUMERATED {dB3, dB6, dB9, dB12, dB15, |

spare3, spare2, spare1},

| | |
|---|---|
| t-SearchDeltaP-Connected-r17 | ENUMERATED {s5, s10, s20, s30, s60, s120, s180, |

s240, s300, spare7, spare6, spare5,

spare4, spare3, spare2, spare1}

| | |
|---|---|
| } | OPTIONAL, -- Need R |

| | |
|---|---|
| goodServingCellEvaluationRLM-r17 | GoodServingCellEvaluation-r17 |

OPTIONAL, -- Need R

| | |
|---|---|
| goodServingCellEvaluationBFD-r17 | GoodServingCellEvaluation-r17 |

OPTIONAL, -- Need R

| | |
|---|---|
| deactivatedSCG-Config-r17 | SetupRelease { DeactivatedSCG-Config-r17 } |

OPTIONAL -- Cond SCG-Opt
]],

| | |
|---|---|
| ltmCellSwitchInfo | SetupRelease { LtmCellSwitchInfo } |

OPTIONAL -- Need M
}

| | |
|---|---|
| LtmCellSwitchInfo-r18 ::= | SEQUENCE { |
| spCellConfigCommon | ServingCellConfigCommon |

OPTIONAL, -- Need M

| | |
|---|---|
| newUE-Identity | RNTI-Value, |
| rach-ConfigDedicated | CHOICE { |
| uplink | RACH-ConfigDedicated, |
| supplementaryUplink | RACH-ConfigDedicated |

| | |
|---|---|
| } | OPTIONAL, -- Need N |

}

### ItmCellSwitchInfo:

This field contains necessary information for the UE to execute an LTM cell switch procedure in case this cell is an LTM target cell.

### LTM-CandidateConfig

The IE LTM-CandidateConfig is used to provide LTM candidate cell configuration.

### LTM-CandidateConfig Information Element

-- ASN1START
-- TAG-LTM-CANDIDATECONFIG-START

| | |
|---|---|
| LTM-CandidateConfig-r18 ::= | SEQUENCE { |

| | |
|---|---|
| lte-ReferenceConfiguration-r18 | OCTET STRING (CONTAINING |
| RRCReconfiguration), | OPTIONAL, -- Cond FirstLTM-Candidate |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-CandidateResetL2-List-r18 | SetupRelease { LTM-CandidateResetL2-List-r18 } |

OPTIONAL -- Need M
...
}
LTM-CandidateToReleaseList-r18 ::= SEQUENCE (SIZE (1..maxNrofCellsLTM-r18)) OF

| | |
|---|---|
| LTM-CandidateId-r18 | OPTIONAL -- Need N |

LTM-CandidateToAddModList-r18 ::= SEQUENCE (SIZE (1..maxNrofCellsLTM-r18)) OF
LTM-Candidate-r18

| | |
|---|---|
| LTM-Candidate-r18 ::= | SEQUENCE { |

| | |
|---|---|
| ltm-CandidateId-r18 | LTM-CandidateId-r18, |

| | |
|---|---|
| ltm-Config-r18 | OCTET STRING (CONTAINING RRCReconfiguration), |

| | |
|---|---|
| ltm-ConfigComplete-r18 | ENUMERATED {true} |

OPTIONAL -- Need R
...
}
LTM-CandidateResetL2-List-r18 ::= SEQUENCE (SIZE (1..maxNrofCellsLTM-r18)) OF
LTM-CandidateId-r18
Note: FFS on whether the LTM-CandidateNoResetL2-List field should include separate reset
flags for MAC, RLC, and PDCP recovery.
-- TAG-LTM-CANDIDATECONFIG-STOP
-- ASN1STOP

### LTM-CandidateConfig Field Descriptions

ltm-Config:

This field includes an RRCReconfiguration message used to configure an LTM candidate cell. This field shall include the CellGroupConfig IE, and it may also include the RadioBearerConfig IE, and MeasConfig IE.

ltm-ConfigComplete:

This field indicates whether the LTM candidate cell configuration within ltm-Config is a complete configuration and thus the UE shall not use the LTM reference configuration within the field lte-ReferenceConfiguration.

ltm-CandidateNoResetL2-List:

This field includes a list of LTM candidate cell identifiers for which the full L2 reset is needed upon an LTM cell switch.

ltm-ReferenceConfiguration:

This field includes an RRCReconfiguration message used to configure a reference configuration for LTM.

### FirstLTM-Candidate:

This field is mandatory present upon the first configuration of LTM-CandidateConfig. Otherwise, the field is optionally present, Need M.

### UE Variables:

### VarLTM-Config:

The IE VarLTM-Config is used to store the reference configuration and the LTM candidate cell configurations.

### VarLTM-Config UE Variable

-- ASN1START
-- TAG-VARLTM-CONFIG-START
VarLTM-Config-r18-IEs ::= SEQUENCE {

| | |
|---|---|
| ltm-ReferenceConfiguration-r18 | OCTET STRING (CONTAINING |

RRCReconfiguration),

| | |
|---|---|
| ltm-CandidateList-r18 | LTM-CandidateList-r18 |

| | |
|---|---|
| ltm-CandidateResetL2-List-r18 | LTM-CandidateResetL2-List-r18 |

```
}
LTM-CandidateList-r18 ::= SEQUENCE (SIZE (1..maxNrofCellsLTM-r18)) OF LTM-
Candidate-r18
LTM-CandidateResetL2-List-r18 ::= SEQUENCE (SIZE (1..maxNrofCellsLTM-r18)) OF
LTM-Candidate-r18
-- TAG-VARLTM-CONFIG-STOP
-- ASN1STOP
  VarLTM-UE-Config:
  The IE VarLTM-UE-Config is used to store the generated UE configuration related
to the received LTM candidate cell configurations.
  VarLTM-UE-Config UE variable:
  -- ASN1START
  -- TAG-VARLTM-CONFIG-START
  VarLTM-UE-Config-r18-IEs ::= SEQUENCE {
```

| | |
|---|---|
| Ue-ltm-ConfigCandidateList-r18 | UE-LTM-ConfigCandidateList-r18 |

```
  }
  UE-LTM-ConfigCandidateList-r18 ::= SEQUENCE (SIZE (1..maxNrofCellsLTM-r18)) OF
  UE-LTM-Config-r18
```

| | |
|---|---|
| UE-LTM-Candidate-r18 ::= | SEQUENCE { |
| ltm-CandidateId-r18 | LTM-CandidateId-r18, |
| ue-LTM-Config-r18 | OCTET STRING, |

```
  }
  -- TAG-VARLTM-CONFIG-STOP
  -- ASN1STOP
```

This field includes an RRCReconfiguration message used to configure an LTM candidate cell. This field shall include the CellGroupConfig IE, and it may also include the RadioBearerConfig IE, and MeasConfig IE.

ltm-ConfigComplete:

This field indicates whether the LTM candidate cell configuration within ltm-Config is a complete configuration and thus the UE shall not use the LTM reference configuration within the field lte-ReferenceConfiguration.

ltm-CandidateNoResetL2-List:

This field includes a list of LTM candidate cell identifiers for which the full L2 reset is needed upon an LTM cell switch.

ltm-ReferenceConfiguration:

This field includes an RRCReconfiguration message used to configure a reference configuration for LTM.

### FirstLTM-Candidate:

This field is mandatory present upon the first configuration of LTM-CandidateConfig. Otherwise, the field is optionally present, Need M.

### UE Variables:

### VarLTM-Config:

The IE VarLTM-Config is used to store the reference configuration and the LTM candidate cell configurations.

The LTM cell switch is supervised by a timer. The timer Tcellswitch is started when the UE receives cell switch command and is stopped once the cell switch is completed. In an option, Tcellswitch is defined as a new timer. In another option, the existing NR RRC timer T304 can be used for supervising LTM cell switch and all the embodiments for Tcellswitch are applicable for T304 when it is used for LTM, such as supervising LTM cell switch. Tcellswitch may be described based on following characteristics:
1: The UE starts the Tcellswitch, upon reception of the LTM cell switch MAC CE;
2: The UE stops the Tcellswitch, upon successful completion of LTM cell switch;
3: If the Tcellswitch for MCG expires, the UE may declare LTM failure and initiate RRC re-establishment.
4. Tcellswitch is RRC layer timer.

### LTM Measurements:

The UE can be configured by the gNB with different measurement configurations for both layer 3 mobility (for e.g., using MeasConfig IE in R17 NR) and LTM. A UE which has been configured with measurement configurations for layer3 mobility (Measurements configured/performed/reported for layer 3 mobility; for e.g., configured through R17 MeasConfig IE, is here in after referred as L3 measurements) and LTM (Measurements configured/performed/reported for LTM is here in after referred as LTM measurements), performs both L3 measurements and LTM measurements. LTM measurements are L1 measurements.

L1 measurement report for LTM is reported as periodic report on PUCCH, semi-persistent report on PUCCH/PUSCH, and aperiodic report on PUSCH. Further, L1 measurements can be reported using MAC CE. The reports may be scheduled by gNB or initiated by UE. It is also possible that gNB can decide for LTM through UL measurements.

The gNB may configure the UE to perform random access towards one or more LTM candidate cells for receiving the timing advance (TA) before the cell switch is performed (known as Early TA). Random access performed on LTM candidate cells for the timing advance reception is known as Random access for early TA. The gNB sends a PDCCH order to initiate RACH for TA measurement for candidate cells. The UE receives PDCCH order from the serving cell. Upon reception of this PDCCH order, the UE initiates RACH for TA measurement for candidate cells on the one or more candidate cell. The UE sends a RACH preamble to the candidate cells and receives the Timing Advance (TA) value from the candidate cell. The TA for candidate cells may be received from the source cell also. Normally, the TA will be received in the random-access response, but it may be also received through a MAC CE.

FIG. 1 shows a block diagram of the wireless communication system, according to embodiments as disclosed herein. In an embodiment herein, the UE (102) comprises a controller (104) and a transceiver (106). The controller (104) communicates to a network apparatus (108) through the transceiver (106). The controller (104) may be implemented through at least one processor. The network apparatus (108) also may comprise at least one processor (110), memory (114) and a transceiver (112). The wireless network may include, but is not limited to, a plurality of network entities available in a network coverage area of the UE.

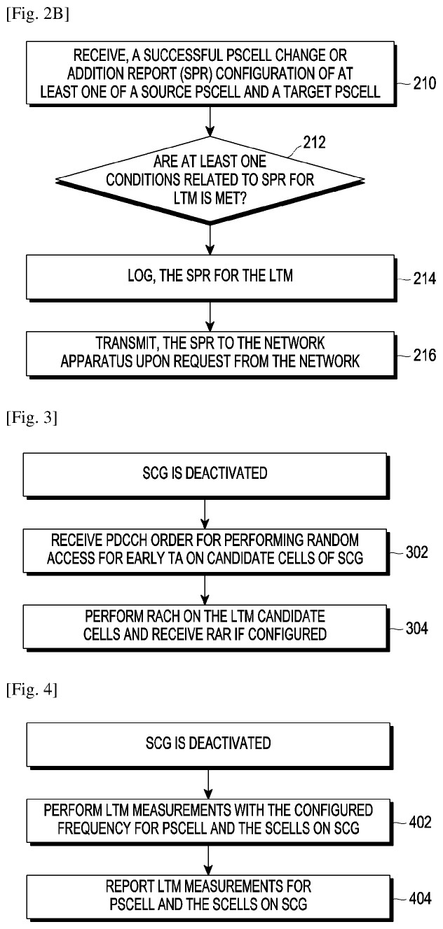

FIGS. 2A and 2B shows a flowchart for a method for managing LTM in a wireless communication network, according to embodiments as disclosed herein. At step 202, the UE (102) may receive a request from a network apparatus to report the UE capabilities. At step 204, the UE (102) may send, to a network apparatus (108), at least one of a first capability of the UE (102) for performing Lower-layer Triggered Mobility (LTM) for a Master Cell Group (MCG) and a second capability of the UE (102) for performing Lower-layer Triggered Mobility (LTM) for a Secondary Cell Group (SCG). In an embodiment herein as shown in FIG. 2B, at step 210, the UE (102) may receive, a Successful PSCell Change or Addition Report (SPR) configuration of at least one of a source Primary SCG Secondary Cell Group cell (PSCell) and a target PSCell in a signaling message from a network apparatus (108) for reporting successful PSCell information. At step 212, the UE (102) may determine, whether at least one conditions related to SPR for LTM is met based on the configuration. At step 214, the UE (102) may log the SPR for the LTM, when the one or more conditions related to LTM are met. At step 216, the UE (102) may transmit the SPR to the network apparatus upon receiving a request to report the logged information.

In an embodiment herein, the UE capability is a per-UE capability. The UE capability is reported in UECapabilityInformation RRC message received by the network apparatus (108). The UE (102) may be configured through the network apparatus (108) for performing at least one of an MCG LTM or a SCG LTM based on the received UE capability.

Embodiments herein disclose methods for self-organizing networks SON for dual connectivity scenarios. Embodiments herein disclose methods for configuration, reporting and releasing the configuration of UE (102) for reporting information related to successful PSCell Addition and Successful PSCell Change. The information may be configured to be stored and reported in a report called Successful PSCell Report (SPR). The SPR may be also called Successful PSCell Addition or Change Report. Alternatively, a separate report may be used for Successful PSCell Addition and Successful PSCell Change. Embodiments herein disclose use the term SPR, but the embodiments herein are applicable even when the gNB configures the UE (102) to report the information separately in different reports for Successful PSCell Addition or Successful PSCell Change Report or when a different abbreviation is used for handling the information for Successful PSCell Addition and Successful PSCell Change. Configuration for reporting information on successful PSCell Change or successful PSCell Addition may be referred to as successPAC-Config herein, but it may be identified by a different abbreviation or variable name. In NR, successPAC-Config may be defined using the same structure successHO-Config-r17, while the sucessPAC-config is used for the configuration for reporting information on successful PSCell Change or successful PSCell Addition and all the embodiments pertaining to successPAC-Config are equally applicable for successHO-Config-r17 used for the configuration for reporting information on successful PSCell Change or successful PSCell Addition.

Embodiments herein disclose methods for performing and optimizing mobility. Embodiments herein disclose successful PSCell change and Successful PSCell addition reporting, SCG Failure and the optimization scenarios for both SCG L3 mobility and SCG LTM. Embodiments herein disclose UE behaviour with LTM for deactivated SCG and SCells.

In an embodiment herein, the UE (102) informs the network apparatus (108) (such as gNB), whether the UE (102) is capable for performing LTM for SCG. In an embodiment herein, the UE (102) informs the network apparatus (108) (such as gNB) whether the UE (102) is capable for performing LTM for MCG. In an embodiment herein, the same capability informs the network apparatus (108) whether the UE (102) is capable of performing LTM for both MCG and SCG. In an embodiment herein, the capability in the embodiments above is a per-UE capability. In an embodiment herein, the capability in the embodiments above is a per-FR capability.

In an embodiment herein, upon receiving the UE (102) performs SCG LTM measurements on a deactivated PSCell (deactivated PSCell in our embodiments also mean the PSCell of the deactivated SCG) and the candidate cells for SCG LTM. In an embodiment herein, the UE (102) receives a periodicity information which informs how often the UE (102) should perform the SCG LTM measurements on the deactivated PSCell and the candidates for SCG LTM. In an embodiment herein, the UE (102) performs MCG LTM measurements on deactivated PSCell, if it is configured as a candidate PSCell.

In an embodiment herein, the UE reports SCG LTM measurements to a deactivated PSCell. In an embodiment herein, the UE receives a periodicity information which informs how often the UE should report the SCG LTM measurements on the deactivated PSCell. In an embodiment herein, the UE reports MCG LTM measurements of deactivated PSCell to PCell, if the PSCell is configured as an LTM candidate cell for MCG.

In an embodiment herein, the UE (102) avoids reporting LTM measurements to a deactivated PSCell. In an embodiment, the UE (102) avoids reporting LTM measurements for the PSCells and any of the candidate cells for the SCG LTM to the deactivated PSCell.

In an embodiment, the UE (102) performs the LTM measurements of cells on deactivated SCG (PSCell and any of the LTM candidate cells for SCG), but does not report those measurements to the PSCell of the SCG through L1/L2 signalling.

In an embodiment, a Master Node (MN) does not deactivate the SCG, if LTM candidate cells are configured for the SCG LTM. In an embodiment, a secondary node (SN) informs the MN whether the SN has configured the LTM candidate cells. In an embodiment, the SN informs the MN whether the SN has configured the LTM candidate cells using F1AP message. The SN informs the MN whether it has configured LTM candidate cells using an RRC InterNodeMessage such as CG-Config.

FIG. 3 depicts the process of performing random access for early TA on deactivated SCG, according to embodiments as disclosed herein. In an embodiment herein, at step 302, if the SCG is deactivated, the UE (102) may receive a PDCCH order to perform random access for early TA on candidate cells of SCG.

At step 304, the UE (102) performs random access (sends radio access channel (RACH preambles) for early timing advance (TA) on a deactivated PSCell, if it is a candidate for MCG LTM. In an embodiment herein, if the SCG LTM is configured, the UE (102) may receive the timing advance RAR or a cell switch command from deactivated SCG.

FIG. 4 depicts the process of performing LTM measurements on a deactivated SCG, according to embodiments as disclosed herein. At step 402, the UE (102) may perform LTM measurements with the configured frequency for PScell and the Scell on SCG. At step 404, the UE (102) may report LTM measurements with the configured frequency for PScell and the Scell on SCG. The UE (102) performing and reporting the LTM measurements is described in the embodiments as below.

In an embodiment herein, the UE (102) may not perform SCG LTM measurements. In an embodiment herein, if the SCG is deactivated, the UE (102) may perform SCG LTM measurements, but reports the LTM measurements only when the SCG is activated. In an embodiment herein, if the SCG is deactivated, the SN avoids configuring the SCG LTM candidate cells. In an embodiment herein, if the SCG is deactivated, the gNB (either SN or MN) releases any configured SCG LTM candidate cells. In an embodiment herein, if a PSCell is deactivated, the UE (102) may not perform early TA on that PSCell. In an embodiment herein, if a PSCell is deactivated, the UE (102) may not perform early TA on any of the LTM candidate cells associated with SCG.

In an embodiment herein, the UE (102) performs LTM measurements on deactivated SCell, if it is configured as an LTM candidate cell (for e.g. for MCG). In an embodiment herein, the UE (102) receives a periodicity information. The periodicity information informs how often the UE (102) should perform the LTM measurements on the deactivated SCell when it is configured as an LTM candidate cell.

In an embodiment herein, the UE (102) receives a periodicity information. The periodicity information informs how often the UE should report the LTM measurements on the deactivated SCell when it is configured as the LTM candidate cell (for e.g., for the MCG).

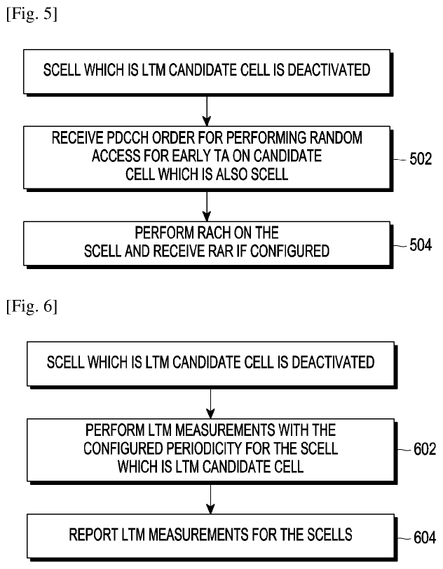

FIG. 5 depicts the process of performing random access for early TA on a deactivated SCell, according to embodiments as disclosed herein. At step 502, f the SCG is deactivated, the UE (102) may receive a PDCCH order to perform random access for early TA on candidate cells of SCG that may also be a Scell. In an embodiment herein, at step 504, the UE (102) performs random access (sends RACH preambles) for early TA on a deactivated SCell, if it is a candidate for LTM (for e.g., for the MCG). In an embodiment herein, the UE (102) performs random access (sends RACH preambles) for early TA on a deactivated SCell, if it is a candidate for LTM and is configured by the network apparatus (108) (such as the gNB) to perform RACH. In an embodiment herein, the configuration of the UE (102) may be done through a flag.

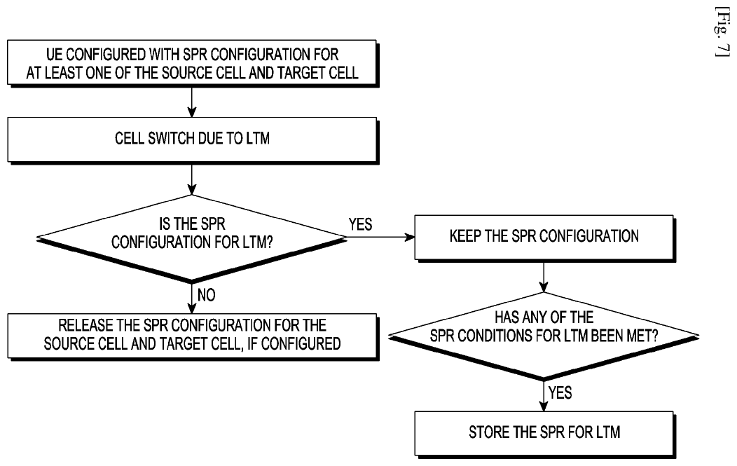

FIG. 6 depicts the process of performing LTM measurements on deactivated Scells, according to embodiments as disclosed herein. At step 602, if the SCell is deactivated, the UE performs SCell LTM measurements, with the configured periodicity for the Scell(s) which is also the LTM candidate cell. At step 604, the UE (102) reports the LTM measurements for the Scell.

In an embodiment herein, if the SCell is deactivated, the UE (102) does not perform SCell LTM measurements. In an embodiment herein, if the SCell is deactivated, the UE (102) performs SCell LTM measurements, but reports them only when the SCell is activated. In an embodiment herein, if the SCell is deactivated, the gNB avoids configuring those SCells as LTM candidate cells. In an embodiment herein, if the SCell is deactivated, the gNB releases any configured LTM candidate cells for those SCells. In an embodiment herein, if a SCell is deactivated, the UE does not perform early TA on that SCell.

In an embodiment herein, the SN does not configure LTM candidate cells if the MN terminated SCG bearers, or split bearers are configured. If the LTM candidate cells are configured, while the MN terminated SCG bearers or split bearers are configured at the SN, the SN releases the LTM candidate configuration.

FIG. 7 depicts the process of handling SPR and LTM, according to embodiments as disclosed herein. The MN retrieves the SPR from the UE (102). The MN performs an initial analysis to identify the node that caused the failure and if the failure is due to SN, the MN forwards SPR to SN. In an embodiment herein, if the spr-cause is T310-failure or T312 failure, the MN forwards the SPR to source SN whereas if the SPR-Cause is T304-failure or Tcellswitch-failure, the MN forwards the SPR to source SN and target SN. SCG Selective Activation and SPR:

In an embodiment herein, the network apparatus (108) avoids including the successPAC-Config in the reference configuration and candidate cell configuration for selective activation of SCG.

In an embodiment herein, the network apparatus (108) may include the successPAC-Config in one or more of the reference configuration or candidate cell configuration(s) for selective activation of SCG.

In an embodiment herein, the UE (102) releases successPAC-Config after a successful PSCell change.

In an embodiment herein, the UE (102) releases successPAC-Config after a successful PSCell change, even when other PSCell configuration is kept due to selective activation of cell groups.

In an embodiment herein, the UE (102) keeps successPAC-Config after a successful PSCell change, when the PSCell configuration is kept due to selective activation of cell groups.

In an alternative embodiment herein, the UE (102) keeps successPAC-Config after a successful PSCell change, when the PSCell configuration is kept due to selective activation of cell groups, but does not log SPR even when the thresholds (conditions) for logging are satisfied.

In an embodiment herein, the UE (102) keeps successPAC-Config after a successful PSCell change, when the PSCell configuration is kept due to selective activation of cell groups, and logs SPR when the thresholds (conditions) for logging are satisfied.

In an embodiment herein, while storing the SPR based on a CPC execution where the target cell was as CPC candidate whose configuration was kept due to SCG selective activation, the UE (102) excludes including the time elapsed between the CPAC execution towards the target cell and the corresponding latest CPAC configuration received for the selected target cell.

In an embodiment herein, while storing the SPR based on a CPC execution where the target cell was as CPC candidate whose configuration was kept due to SCG selective activation, the UE (102) includes the time elapsed between the CPAC execution towards the target cell and the corresponding latest CPAC configuration received for the selected target cell as zero.

In an embodiment herein, while storing the SPR based on a CPC execution where the target cell was as CPC candidate whose configuration was kept due to SCG selective activation, the UE (102) includes the time elapsed between the CPAC execution towards the target cell and the corresponding latest CPAC configuration received for the selected target cell to an arbitrary value.

In an embodiment herein, while storing the SPR based on a CPC execution where the target cell was as CPC candidate whose configuration was kept due to SCG selective activation, the UE (102) also logs information in the SPR, for the network apparatus (108) to identify that the SPR is stored for a CPC execution, where the target cell was as CPC candidate whose configuration was kept due to SCG selective activation. In an embodiment herein, this information is provided by including an explicit flag. In an embodiment herein, this flag informs the network apparatus (108) that the SPR is stored for a CPC execution where the target cell was as CPC candidate whose configuration was kept due to SCG selective activation.

In an embodiment herein, while storing the SPR based on a CPC execution where the target cell was as CPC candidate whose configuration was kept due to SCG selective activation, the UE (102) informs the network apparatus (108) to identify that the SPR is stored for a CPC execution where the target cell was as CPC candidate whose configuration was kept due to SCG selective activation, by including one or more fields which are included only for CPC execution where the target cell was as CPC candidate whose configuration was kept due to SCG selective activation.

In an embodiment herein, while storing the SPR based on a CPC execution where the target cell was as CPC candidate whose configuration was kept due to SCG selective activation, the UE (102) informs the network apparatus (108) to identify that the SPR is stored for a CPC execution where the target cell was as CPC candidate whose configuration was kept due to SCG selective activation, by including one or more values for one or more fields where those values are included only for CPC execution where the target cell was as CPC candidate whose configuration was kept due to SCG selective activation.

In an embodiment herein, while storing the SPR based on a CPC execution due to SCG selective activation, the UE (102) also logs information in the SPR, for the network apparatus (108) to identify that the SPR is stored for a CPC execution due to SCG selective activation. In an embodiment herein, this information is provided by including an explicit flag.

In an embodiment herein, while storing the SPR based on a CPC execution due to SCG selective activation, the UE (102) informs the network apparatus (108) to identify that the SPR is stored for a CPC execution due to SCG selective activation, by including one or more fields which are included only for CPC execution due to SCG selective activation.

In an embodiment herein, while storing the SPR based on a CPC execution due to SCG selective activation, the UE (102) informs the network apparatus (108) to identify that the SPR is stored for a CPC execution due to SCG selective activation, by including one or more values for one or more fields which are included only for CPC execution due to SCG selective activation.

### LTM Impacts on SPR for L3 Mobility:

In an embodiment herein, a UE (102) which has been configured with configuration for reporting successful PSCellChange or PSCellAddition (such as successPAC-Config, the configuration for reporting successful PSCellChange or PSCellAddition is referred to herein as a successPAC-Config), releases this configuration during the execution of LTM cell switch for SCG.

In an embodiment herein, upon receiving cell switch command for SCG from the network, the UE (102) releases the successPAC-Config. In an embodiment herein, this release is performed by the UE RRC layer upon receiving information from the lower layers (such as MAC) that the lower layers have received cell switch command for SCG from the network. In an embodiment herein, this release is performed when the successPAC-Config is for the logging and reporting of successful SCG L3 mobility. In an embodiment herein, this release is not performed when the successPAC-Config is for the logging and reporting of successful LTM for SCG. In an alternative, embodiment herein, this release is performed when the successPAC-Config is for the logging and reporting of successful SCG L3 mobility and LTM for the SCG.

In an embodiment herein, upon receiving cell switch command for SCG from the network, the UE (102) releases the successPAC-Config configured for SCG L3 mobility configured by the source SCG cell.

In an embodiment herein, upon receiving cell switch command from the network, the UE (102) releases the successPAC-Config, configured for SCG L3 mobility configured by the source cell and the T304 threshold configured by the target SCG cell.

In an embodiment herein, a UE (102) which has been configured with configuration for reporting successful PSCellChange or PSCellAddition (such as successPAC-Config), releases this configuration during the execution of LTM cell switch for MCG. In an embodiment herein, upon receiving cell switch command for MCG from the network, the UE (102) releases the successPAC-Config. In an embodiment herein, this release is performed by UE RRC layer upon receiving information from the lower layers (such as MAC) that the lower layers have received cell switch command for MCG from the network. In an embodiment herein, this release is performed when the successPAC-Config is for the logging and reporting of successful SCG L3 mobility. In an embodiment herein, this release is not performed when the successPAC-Config is for the logging and reporting of successful LTM for SCG. In an alternative embodiment herein, this release is performed when the successPAC-Config is for the logging and reporting of successful SCG L3 mobility and LTM for SCG.

In an embodiment herein, upon receiving cell switch command for MCG from the network, the UE (102) releases successPAC-Config. In an embodiment herein, upon receiving cell switch command for MCG from the network, the UE (102) releases successPAC-Config configured by the source SCG cell and the T304 threshold configured by the target SCG cell.

In an embodiment herein, a UE (102) which includes the measurements for a neighbour SCG cell in SPR also includes whether the neighbour SCG cell is an LTM candidate cell.

An example sequence capturing some of the embodiments in TS 38.331 is given below:

### 5.3.5.x.5 LTM Cell Switch Execution

Upon the indication by lower layers that an LTM cell switch procedure is triggered, the UE (102) shall:
1> release/clear all current dedicated radio configuration associated with the cell group for which the procedure for the LTM cell switch is triggered except for the following:
2> if the LTM cell switch is triggered on the MCG:
   the MCG C-RNTI;
   the AS security configurations associated with the master key;
2> else, if the LTM cell switch is triggered on the SCG:
   the SCG C-RNTI;
   the AS security configurations associated with the secondary key;
   the SRB1/SRB2 configurations and DRB configurations as configured by radioBearerConfig or radioBearerConfig2;
   the UE (102) variables VarLTM-Config and VarLTM-UE-Config.
1> release/clear all current common radio configuration associated with the cell group for which the procedure for the LTM cell switch is triggered;
1> use the default values specified in 9.2.3 for timers T310, T311 and constants N310, N311 associated with the cell group for which the procedure for the LTM cell switch is triggered;
1> apply the default L1 parameter values as specified in corresponding physical layer specifications except for the following:
   parameters for which values are provided in SIB1;
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation as specified in TS 38.323, and with the same security configuration as the PDCP entity for the source cell group;
1> stop timer T310 for the corresponding SpCell, if running;
1> if this procedure is executed for the SCG:
2> release successPAC-Config configured by the source PCell and thresholdPercentageT304 if configured by the target PCell.

In an embodiment a UE (102) which has been configured with successPAC-Config, releases successPAC-Config when the SCG LTM cell switch is successful.

In an embodiment herein, a UE (102) which has been configured with successPAC-Config, releases successPAC-Config when the SCG LTM cell switch has failed.

In an alternative embodiment herein, a UE (102) which has been configured with successPAC-Config, keeps successPAC-Config when the SCG LTM cell switch is successful.

In an alternative embodiment herein, a UE (102) which has been configured with successPAC-Config, keeps successPAC-Config when the SCG LTM cell switch has failed.

In an embodiment herein, a UE (102) which is configured with SCG LTM candidate cells stores the LTM measurements, if available in the SPR for L3 mobility.

In an embodiment herein, a UE (102) which is configured with SCG LTM candidate cells stores the LTM measurements, if available in the SPR for L3 mobility, if there is no L3 measurements available for those candidate cells.

In an embodiment herein, a UE which is configured with SCG LTM candidate cells stores the LTM measurements, if available in the SPR for L3 mobility, if there is no L3 measurement object configured for those cells (configured for the corresponding frequency). In an embodiment herein, the UE (102) includes the latest LTM measurements in the SPR for L3 mobility. In an embodiment herein, the UE (102) sends the average of LTM measurements over a specific period of time to the network apparatus (108) in SPR for L3 mobility. In an embodiment herein, LTM measurements can be one of the periodic measurements, aperiodic measurements, semi periodic measurements or event-based measurements performed by UE (102) as configured by gNB for LTM. In an embodiment herein, the LTM measurements included in SPR are RSRP (Reference Signal Received Power) measurements. In an embodiment herein, the LTM measurements included in SPR for L3 mobility are SINR (Signal to Interference and Noise Ratio) measurements. In an embodiment herein, the LTM measurements included in SPR for L3 mobility are RSRQ (Reference Signal Received Quality) measurements.

A UE (102) configured with both LTM and L3 measurements for the same cell includes only L3 measurements in the SPR for L3 mobility. In an alternate embodiment herein, a UE (102) configured with both LTM and L3 measurements for the same cell includes both LTM and L3 measurements in the SPR for L3 mobility. In an alternate embodiment herein, a UE (102) configured with both LTM and L3 measurements for the same cell includes LTM measurements in the SPR for L3 mobility.

Successful PSCell Change Report for LTM:

In an embodiment herein, the UE (102) informs the network apparatus (108) (such as gNB) whether it is capable for logging and reporting the SPR for LTM. In an embodiment herein, the UE (102) informs the network apparatus (108) (such as gNB) whether it is capable for logging and reporting the SHR (Successful Handover Report) for LTM. In an embodiment herein, the same capability bit can be used for informing the network apparatus (108) whether the UE (102) is capable of logging and reporting the SHR for LTM and SPR for LTM. In an embodiment herein, the capability in the embodiments above is a per-UE capability. In an embodiment herein, the capability in the embodiments above is a per-FR capability.

In an embodiment herein, the UE (102) receives from the network apparatus (108) (such as gNB) a configuration for reporting the SPR for LTM (such a configuration is referred to herein as “successful LTM report configuration for PSCell Change”). In an embodiment herein, this is received using the same NR RRC IE for SPR configuration (such as successPAC-Config). In an embodiment herein, this configuration is received using a new NR IE. In an embodiment herein, this configuration is received within RRC IE OtherConfig.

In an embodiment herein, the successful LTM report configuration for PSCell Change includes a threshold percentage for timers T310 and T312. In an embodiment successful LTM report configuration for PSCell Change is provided in RRC messages such as RRC Reconfiguration and RRC Resume. In an embodiment herein, the threshold percentage for timer T310 for LTM as mentioned above is configured using NR RRC IE thresholdPercentageT310. In an embodiment herein, the threshold percentage for timer T310 for LTM as mentioned above is configured using a new NR RRC IE.

In an embodiment herein, if the ratio between the value of the elapsed time of the timer T310 in SCG and the configured value of the timer T310, is greater than threshold percentage for timer T310 for LTM as included in the successful LTM report configuration for PSCell Change, the UE (102) stores the SPR for LTM. In an embodiment herein, a NR UE (102) sets t310-cause in spr-Cause (or the same cause value used for SPR for L3 mobility) as true in this case.

In an embodiment herein, if the ratio between the value of the elapsed time of the timer T312 and the configured value of the applicable timer T312, is greater than threshold percentage for timer T312 for LTM as included in the successful LTM report configuration for PSCell Change, the UE (102) stores the SPR for LTM. In an embodiment herein, a NR UE (102) sets t312-cause in spr-Cause (or the same cause value used for SPR for L3 mobility) as true in this case.

In an embodiment herein, the threshold percentage for T310, T312 in successful LTM report configuration for PSCell Change includes some of the values as defined below (p20 means 20 percentage, p40 means 40 percentage, p60 means 60 percentage, p80 means 80 percentage and so on):

| | |
|---|---|
| thresholdPercentageT310-r17 | ENUMERATED {p40, p60, p80, spare5, spare4, spare3, |
| spare2, spare1} OPTIONAL, -- Need R | |
| thresholdPercentageT312-r17 | ENUMERATED {p20, p40, p60, p80, spare4, spare3, |
| spare2, spare1} OPTIONAL, -- Need R | |

In an embodiment herein, the threshold percentage for T310 and T312 in successful LTM report configuration for PSCell Change are configured by the source cell. In an embodiment herein, threshold percentage for T310 and T312 in successful LTM report configuration for PSCell Change are included in the RRC message generated by the source cell.

In an embodiment herein, the threshold may be an absolute number such as delay instead of a percentage.

In an embodiment herein, the successful LTM report configuration for PSCell Change includes a threshold for the timer Tcellswitch. In an embodiment herein, the successful LTM report configuration for PSCell Change includes a threshold percentage for timer Tcellswitch (the threshold percentage may be referred to as thresholdPercentageTcellswitch herein). In an embodiment herein, the successful LTM report configuration for SCG includes the threshold percentage for timer Tcellswitch, thresholdPercentageTcellswitch. In an embodiment herein, thresholdPercentageTcellswitch is set by the target gNB and is included in target cell's RRC configuration message. In an embodiment herein, the thresholdPercentageTcellswitch is configured in the LTM candidate configuration (such as LTM-Candidate-r18 in the background). In an example herein, the thresholdPercentageTcellswitch includes one or more of the following values: 20 percentage, 40 percentage, 60 percentage and 80 percentage. In an example herein, the thresholdPercentageTcellswitch includes the following values: 40 percentage, 60 percentage and 80 percentage.

In an embodiment herein, if the ratio between the value of the elapsed time of the timer Tcellswitch and the configured value of the timer Tcellswitch, is greater than thresholdPercentageTcellswitch as included in the successful LTM report configuration for PSCell Change, the UE (102) stores the SPR for LTM. In an embodiment herein, the UE (102) stores the SPR cause (spr-cause) is due to tcellswitch. In an embodiment herein, the UE (102) sets tcellswitch-cause in spr-Cause (or any equivalent value) as true in this case.

In an embodiment herein, the criteria for threshold matching (for T310, T312, Tcellswitch thresholds) is based on “greater than or equal to” than “greater than”.

In an embodiment herein, a UE (102) which is configured with SCG LTM candidate cells or LTM measurements for SCG stores the LTM measurements for SCG, if available in the SPR for LTM.

In an embodiment herein, the UE (102) includes the latest LTM measurements for SCG in the SPR for LTM. In an embodiment herein, the latest measurements are the last measurements taken. In an embodiment herein, the latest measurements are the last measurements reported. In an embodiment herein, the UE (102) sends the average of LTM measurements over a specific period of time to the network apparatus (108) in SPR for LTM. In an embodiment herein, the LTM measurements can be one of the periodic measurements, aperiodic measurements, semi periodic measurements, or event-based measurements performed by UE (102) as configured by the gNB for LTM. In an embodiment herein, the LTM measurements included in SPR are RSRP (Reference Signal Received Power) measurements. In an embodiment herein, the LTM measurements included in SPR for LTM are SINR (Signal to Interference and Noise Ratio) measurements. In an embodiment herein, the LTM measurements included in SPR for LTM are RSRQ (Reference Signal Received Quality) measurements.

A UE (102) configured with both LTM and L3 measurements for the same cell includes only L3 measurements in the SPR for LTM. In an alternate embodiment herein, a UE (102) configured with both LTM and L3 measurements for the same cell includes both LTM and L3 measurements in the SPR for LTM. In an alternate embodiment herein, a UE (102) configured with both LTM and L3 measurements for the same cell includes LTM measurements in the SPR for LTM.

In an embodiment herein, a UE (102) configured for SPR for LTM logs and reports the following information in the SPR:

The fields included in the SPR for L3 handover and LTM by the UE (102) are as follows:
c-RNTI: This field indicates the C-RNTI assigned by the target PSCell of the PSCell Addition or PSCell Change for which the SPR was generated.
measResultListNR: This field refers to the last measurement results taken in the neighboring NR Cells when a successful PSCell Addition or PSCell Change (including LTM) is executed.
LTMmeasResultListNR: This field refers to the last LTM measurement results taken in the neighboring NR Cells when a successful PSCell Addition or PSCell Change (including LTM) is executed.
spr-Cause: This field is used to indicate the cause of the SPR.
sourceCellMeas: This field refers to the last measurement results taken in the source PCell of a PSCellChange or LTM in which the successful PSCell Change trigger SPR or successful LTM triggers the SPR.
LTMsourceCellMeas: This field refers to the last measurement results taken in the source PSCell of a PSCellChange or LTM in which the successful PSCell Change trigger SPR or LTM triggers the SPR.
sourcePSCellId: This field is used to indicate the source PCell of a PSCellChange or LTM in which the successful PSCell Change trigger SPR or successful LTM triggers the SPR.
targetPSCellId: This field is used to indicate the target PSCell of a PSCellChange or LTM in which the successful PSCell change or LTM triggers the SPR or the PSCell where successful PSCell Addition triggers the SPR.
TargetCellMeas: This field refers to the last measurement results taken in the target PSCell of a PSCell change or PSCell Addition in which the successful PSCell change or successful PSCell Addition triggers the SPR.
LTMtargetCellMeas: This field refers to the last LTM measurement results taken in the target PSCell of a of a PSCellChange or LTM in which the successful PSCell Change trigger SPR or LTM triggers the SPR.
timeSinceCPAC-Reconfig: This field is used to indicate the time elapsed between the initiation of the last conditional PSCell addition or PSCell change execution towards the target cell and the reception of the latest conditional reconfiguration for this target cell. Actual value=field value*100 ms. The maximum value 1023 means 102.3s or longer. This field is not included if the CPC is executed due to SCG selective activation.

In an embodiment herein, the above embodiments can be captured in 3gpp specification TS 38.331 as below example embodiments. In the below section, the same variable name is considered for successful handover reporting and successful handover reporting configuration for LTM and L3 handover.

### 5.7.10.6 Actions for the SPR Determination

The UE (102) shall for the PSCell:
1> if the ratio between the value of the elapsed time of the timer T304 for PSCell and the configured value of the timer T304 for PSCell, included in the last applied RRCReconfiguration message including the reconfigurationWithSync, is greater than thresholdPercentageT304 if included in the successPAC-Config received or stored due to selective activation of cellgroups before executing the last reconfiguration with sync for the PSCell; or
1> if the ratio between the value of the elapsed time of the timer T310 for PSCell and the configured value of the timer T310 for PSCell, configured while the UE (102) was connected to the source PSCell or stored due to selective activation of cell groups before executing the last reconfiguration with sync or cell switch, is greater than thresholdPercentageT310 included in the successPAC-Config if configured by the source PSCell before executing the last reconfiguration with sync or cell switch; or
1> if the T312 associated to the measurement identity of the target PScell was running at the time of initiating the execution of the reconfiguration with sync procedure and if the ratio between the value of the elapsed time of the timer T312 for PSCell and the configured value of the timer T312 for PSCell, configured while the UE (102) was connected to the source PSCell or stored due to selective activation of cellgroups before executing the last reconfiguration with sync or cell switch, is greater than thresholdPercentageT312 included in the successPAC-Config if configured by the source PSCell before executing the last reconfiguration with sync or cell switch; or
1> if the ratio between the value of the elapsed time of the timer Tcellswitch for PSCell and the configured value of the timer Tcellswitch for PSCell, included in the last applied LTM candidate cell configuration or LTM reference configuration, is greater than thresholdPercentageTcellswitch if included in the successPAC-Config received before executing the last cell switch command:
2> store the successful PSCell change or addition information in VarSuccessPAC-Report and determine the content in VarSuccessPAC-Report as follows:
3> clear the information included in VarSuccessPAC-Report, if any;
3> set the plmn-IdentityList to include the list of EPLMNs stored by the UE (102) (i.e., includes the RPLMN) and also include the list of equivalent NPNs;
3> set the c-RNTI to the C-RNTI assigned by the target PSCell of the PSCell Addition or PSCell Change or LTM;
3> for the source PSCell in which the last RRCReconfiguration message including reconfigurationWithSync was applied or from which cell switch command is received:
set the sourcePSCellID in sourcePSCellInfo to the global cell identity and tracking area code, if available, of the source PSCell;
4> set the sourceCellMeas in sourceCellInfo to include the cell level RSRP, RSRQ and the available SINR, of the source PSCell based on the available SSB and CSI-RS measurements collected up to the moment the UE (102) sends RRCReconfigurationComplete message;
4> set the rsIndexResults in LTMsourceCellMeas to include all the available LTM SSB and LTM CSI-RS measurement quantities of the source PSCell collected up to the moment the UE (102) sends RRCReconfigurationComplete message;
4> set the LTMsourceCellMeas in LTMsourceCellInfo to include the cell level RSRP, RSRQ and the available SINR, of the source PSCell based on the available LTM SSB and LTM CSI-RS measurements collected up to the moment the UE (102) sends RRCReconfigurationComplete message;
4> set the rsIndexResults in sourceCellMeas to include all the available SSB and CSI-RS measurement quantities of the source PSCell collected up to the moment the UE (102) sends RRCReconfigurationComplete message;
4> set the sourceCellID in LTMsourceCellInfo to the global cell identity and tracking area code, if available, of the source PSCell;
4> set the sourceCellMeas in LTMsourceCellInfo to include the cell level RSRP, RSRQ and the available SINR, of the source PSCell based on the available SSB and CSI-RS measurements collected up to the moment the UE (102) sends RRCReconfigurationComplete message;
4> set the rsIndexResults in LTMsourceCellMeas to include all the available LTM SSB and LTM CSI-RS measurement quantities of the source PSCell collected up to the moment the UE (102) sends RRCReconfigurationComplete message;
4> set the LTMsourceCellMeas in LTMsourceCellInfo to include the cell level RSRP, RSRQ and the available SINR, of the source PSCell based on the available LTM SSB and LTM CSI-RS measurements collected up to the moment the UE (102) sends RRCReconfigurationComplete message;
4> set the rsIndexResults in LTMsourceCellMeas to include all the available SSB and CSI-RS measurement quantities of the source PSCell collected up to the moment the UE (102) sends RRCReconfigurationComplete message;
3> for the target PSCell indicated in the last applied RRCReconfiguration message including reconfigurationWithSync or the last received cell switch command:
4> set the targetCellID in targetCellInfo to the global cell identity and tracking area code, if available, of the target PSCell;
4> set the targetCellMeas in targetCellInfo to include the cell level RSRP, RSRQ and the available SINR, of the target PCell based on the available SSB and CSI-RS measurements collected up to the moment the UE (102) sends RRCReconfigurationComplete message;
4> set the rsIndexResults in targetCellMeas to include all the available SSB and CSI-RS measurement quantities of the target PSCell collected up to the moment the UE (102) sends RRCReconfigurationComplete message;
3> for the target PSCell indicated in the last received cell switch command:
4> set the targetCellID in LTMtargetCellInfo to the global cell identity and tracking area code, if available, of the target PSCell;
4> set the LTMtargetCellMeas in LTMtargetCellInfo to include the cell level RSRP, RSRQ and the available SINR, of the target PSCell based on the available SSB and CSI-RS measurements collected up to the moment the UE (102) sends RRCReconfigurationComplete message;
4> set the rsIndexResults in LTMtargetCellMeas to include all the available SSB and CSI-RS measurement quantities of the target PSCell collected up to the moment the UE (102) sends RRCReconfigurationComplete message;
4> if the last applied RRCReconfiguration message including reconfigurationWithSync was included in the stored conditional cell switch command:
5> set the timeSinceCHO-Reconfig to the time elapsed between the initiation of the execution of conditional reconfiguration for the target PCell and the reception of the last conditionalReconfiguration including the condRRCReconfig of the target PCell in the source PCell;
3> if the ratio between the value of the elapsed time of the timer T304 and the configured value of the T304 timer, included in the last applied RRCReconfiguration message including the reconfigurationWithSync or the last received cell switch command, is greater than thresholdPercentageT304 if included in the successHO-Config received before executing the last reconfiguration with sync:
4> set t304-cause in shr-Cause to true;
4> set the ra-InformationCommon to include the random-access related information associated to the random access procedure in the target PCell, as specified in clause 5.7.10.5;
3> if the ratio between the value of the elapsed time of the timer T310 and the configured value of the T310 timer, configured while the UE (102) was connected to the source PSCell before executing the last reconfiguration with sync or cell switch command, is greater than thresholdPercentageT310 included in the successPAC-Config if configured by the source PSCell before executing the last reconfiguration with sync or stored due to selective activation of cell groups:
4> set t310-cause in spr-Cause to true;
3> if the T312 associated to the measurement identity of the target cell was running at the time of initiating the execution of the reconfiguration with sync procedure and if the ratio between the value of the elapsed time of the timer T312 and the configured value of the T312 timer, configured while the UE (102) was connected to the source PSCell before executing the last reconfiguration with sync or cell switch command, is greater than thresholdPercentageT312 included in the successPAC-Config if configured by the source PCell before executing the last reconfiguration with sync or stored due to selective activation of cell groups:
4> set t312-cause in spr-Cause to true;
3> for each of the measObjectNR, configured by the source PSCell, in which the last RRCReconfiguration message including reconfigurationWithSync was applied:
4> if measurements are available for the measObjectNR:
5> if the SS/PBCH block-based measurement quantities are available:
6> set the measResultListNR in measResultNeighCells to include all the available measurement quantities of the best measured cells, other than the source PSCell or target PSCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE (102) sends the RRCReconfigurationComplete message;
6> for each neighbour cell included, include the optional fields that are available;
NOTE 1: For the neighboring cells set included in measResultListNR in measResultNeighCells ordered based on the SS/PBCH block measurement quantities, the UE (102) also includes the CSI-RS based measurement quantities, if available.
5> if the CSI-RS measurement quantities are available:
6> set the measResultListNR in measResultNeighCells to include all the available measurement quantities of the best measured cells, other than the source PSCell and target PSCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE (102) sends the RRCReconfigurationComplete message;
6> for each neighbour cell included, include the optional fields that are available;
NOTE 2: For the neighboring cells set ordered based on the CSI-RS measurement quantities, the UE (102) includes measurements only for the cells not yet included in measResultListNR in measResultNeighCells to avoid overriding SS/PBCH block-based ordered measurements.
3> for each of the neighbour cells included in measResultNeighCells:
4> if the cell was a candidate target cell included in the condRRCReconfig for SCG within the conditionalReconfiguration configured by the source PSCell or PCell, in which the last RRCReconfiguration message including reconfigurationWithSync was applied:
5> set the CPACCandidate to true in measResultNR;
3> for each of the LTM measurement object for SCG, configured in the UE (102):
4> if measurements are available for the LTM measurements:
5> if the SS/PBCH block-based measurements are available:
6> set the measResultListNR in LTMmeasResultNeighCells to include all the available measurement quantities of the measured LTM candidate cell cells, other than the source PCell in LTM or target PCell in LTM, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE (102) sends the RRC Reconfiguration Complete;
6> for each neighbour cell included, include the optional fields that are available;
NOTE 1: For the neighboring cells set included in measResultListNR in LTMmeasResultNeighCells ordered based on the SS/PBCH block measurement quantities, the UE (102) also includes the CSI-RS based measurement quantities, if available.
5> if the CSI-RS measurement quantities are available:
6> set the measResultListNR in LTMmeasResultNeighCells to include all the available measurement quantities of the LTM candidate cell, other than the source LTM PCell and target LTM PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE (102) sends the RRCReconfigurationComplete message;
6> for each neighbour cell included, include the optional fields that are available;
NOTE 2: For the neighboring cells set ordered based on the CSI-RS measurement quantities, the UE (102) includes measurements only for the cells not yet included in measResultListNR in LTMmeasResultNeighCells to avoid overriding SS/PBCH block-based ordered measurements.
3> for each of the neighbour cells included in measResultNeighCells and LTM measResultNeighCells:
4> if the cell was a candidate LTM cell:
5> set the LTMCandidate to true in measResultNR;
3> if available, set the locationInfo as in 5.3.3.7;
1> release successHO-Config configured by the source PCell and thresholdPercentageT304 if configured by the target PCell.

The UE (102) may discard the SPR for LTM, i.e., release the UE (102) variable for storing SPR for LTM, 48 hours after the last successful PSCellChange information for LTM is added to the variable for storing SPR for LTM.

| | |
|---|---|
| SuccessPAC-Report-r18 ::= | SEQUENCE { |
| sourceCellInfo-r18 | SEQUENCE { |

| | |
|---|---|
| sourcePSCellId-r17 | CGI-Info-Logging-r16, |
| sourceCellMeas-r17 | MeasResultSuccessHONR-r17 |

OPTIONAL,

| | |
|---|---|
| rlf-InSourceDAPS-r17 | ENUMERATED {true} |

```
  OPTIONAL
    },
```

| | |
|---|---|
| targetCellInfo-r17 | SEQUENCE { |

| | |
|---|---|
| targetPSCellId-r17 | CGI-Info-Logging-r16, |
| targetCellMeas-r17 | MeasResultSuccessHONR-r17 |

```
  OPTIONAL
    },
```

| | |
|---|---|
| measResultNeighCells-r17 | SEQUENCE { |
| measResultListNR-r17 | MeasResultList2NR-r16 |

OPTIONAL,

| | |
|---|---|
| measResultListEUTRA-r17 | MeasResultList2EUTRA-r16 |

OPTIONAL

| | |
|---|---|
| } | OPTIONAL, |

| | |
|---|---|
| locationInfo-r17 | LocationInfo-r16 |

OPTIONAL,

| | |
|---|---|
| timeSinceCPAC-Reconfig-r17 | TimeSinceCPAC-Reconfig-r18 |

OPTIONAL,

| | |
|---|---|
| spr-Cause-r17 | SPR-Cause-r17 |

OPTIONAL,

| | |
|---|---|
| ra-InformationCommon-r17 | RA-InformationCommon-r16 |

OPTIONAL,

| | | |
|---|---|---|
| c-RNTI-r17 | RNTI-Value | OPTIONAL, |

| | |
|---|---|
| LTMsourceCellInfo-r17 | SEQUENCE { |
| sourcePSCellId-r17 | CGI-Info-Logging-r16, |
| LTMsourceCellMeas-r17 | LTMMeasResultSuccessHONR-r18 |

OPTIONAL,

| | |
|---|---|
| rlf-InSourceDAPS-r17 | ENUMERATED {true} |

```
    OPTIONAL
      },
```

| | |
|---|---|
| LTMtargetCellInfo-r17 | SEQUENCE { |
| targetPSCellId-r17 | CGI-Info-Logging-r16, |
| LTMtargetCellMeas-r17 | LTMMeasResultSuccessHONR-r18 |

```
    OPTIONAL
      },
```

| | |
|---|---|
| LTMmeasResultNeighCells-r17 | SEQUENCE { |
| measResultListNR-r17 | LTMMeasResultList2NR-r18 |

OPTIONAL,

| | |
|---|---|
| } | OPTIONAL, |

}

In an embodiment herein, upon receiving a cell switch command from the network, the UE (102) keeps the SPR configuration configured for LTM. Configured T310/T312 thresholds in the SPR configuration will be used again if there is another mobility from the same source cell. Configured the Tcellswitch threshold in the SPR configuration will be used again if there is another mobility to the same target PSCell.

In an embodiment herein, upon receiving a cell switch command from the network, the UE (102) keeps the SPR configuration configured for LTM and may later release the SPR configuration configured for LTM upon explicitly released by the network apparatus (108)(such as gNB) or RRC Reestablishment or RRC Release (for both the transition to RRC_IDLE and RRC_INACTIVE).

In an embodiment herein, the source CU forwards the received SPR for LTM to the source DU. In an embodiment herein, the source DU updates the conditions for performing LTM, upon receiving SPR from the source CU. In an embodiment herein, the target CU forwards the received SPR for LTM to the target DU. In an embodiment herein, the target DU updates the configurations for performing LTM, upon receiving the SPR from the source CU.

In an embodiment herein, the UE (102) informs the network apparatus (108) whether it supports SCG failure for mobility robustness optimization for LTM. In an embodiment herein, the UE (102) will inform the network apparatus (108) of the same through a capability bit send in UE capability Information.

In an embodiment herein, the UE (102) which has received cell switch command and has experienced SCG RLF informs the network. In an embodiment herein, the information that the UE (102) sends to the network apparatus (108) are as per below embodiments:

### 5.7.3.5 Actions Related to Transmission of SCGFailureInformation Message:

The UE (102) shall set the contents of the SCGFailureInformation message as follows:
1> if the UE (102) initiates transmission of the SCGFailureInformation message due to T310 expiry:
2> set the failureType as t310-Expiry;
1> else if the UE (102) initiates transmission of the SCGFailureInformation message due to T312 expiry:
2> set the failureType as other and set the failureType-v1610 as t312-Expiry;
1> else if the UE (102) initiates transmission of the SCGFailureInformation message to provide reconfiguration with sync failure information for an SCG:
2> set the failureType as synchReconfigFailureSCG;
1> else if the UE (102) initiates transmission of the SCGFailureInformation message to provide random access problem indication from SCG MAC:
2> if the random access procedure was initiated for beam failure recovery:
3> set the failureType as other and set the failureType-v1610 as beamFailureRecoveryFailure;
2> else:
3> set the failureType as randomAccessProblem;
1> else if the UE (102) initiates transmission of the SCGFailureInformation message to provide indication from SCG RLC that the maximum number of retransmissions has been reached:
2> set the failureType as rlc-MaxNumRetx;
1> else if the UE (102) initiates transmission of the SCGFailureInformation message due to SRB3 IP check failure:
2> set the failureType as srb3-IntegrityFailure;
1> else if the UE (102) initiates transmission of the SCGFailureInformation message due to Reconfiguration failure of NR RRC reconfiguration message:
2> set the failureType as scg-reconfigFailure;
1> else if the UE (102) initiates transmission of the SCGFailureInformation message due to consistent uplink LBT failures:
2> set the failureType as other and set the failureType-v1610 as scg-lbtFailure;
1> else if connected as an IAB-node and the SCGFailureInformation is initiated due to the reception of a BH RLF indication on BAP entity from the SCG:
2> set the failureType as other and set failureType-v1610 as bh-RLF;
1> else if the UE (102) initiates transmission of the SCGFailureInformation message due to beam failure of the PSCell while the SCG is deactivated:
2> set the failureType as other and set failureType-v1610 as beamFailure;
1> include and set MeasResultSCG-Failure in accordance with 5.7.3.4;
1> for each MeasObjectNR configured by a MeasConfig associated with the MCG, and for which measurement results are available:
2> include an entry in measResultFreqList;
2> if there is a measId configured with the MeasObjectNR and a reportConfig which has rsType set to ssb:
3> set ssbFrequency in measResultFreqList to the value indicated by ssbFrequency as included in the MeasObjectNR;
2> if there is a measId configured with the MeasObjectNR and a reportConfig which has rsType set to csi-rs:
3> set refFreqCSI-RS in measResultFreqList to the value indicated by refFreqCSI-RS as included in the associated measurement object;
2> if a serving cell is associated with the MeasObjectNR:
3> set measResultServingCell in measResultFreqList to include the available quantities of the concerned cell and in accordance with the performance requirements in TS 38.133 [14];
2> set the measResultNeighCellList in measResultFreqList to include the best measured cells, ordered such that the best cell is listed first, and based on measurements collected up to the moment the UE (102) detected the failure, and set its fields as follows;
3> ordering the cells with sorting as follows:
4> based on SS/PBCH block if SS/PBCH block measurement results are available and otherwise based on CSI-RS;
4> using RSRP if RSRP measurement results are available, otherwise using RSRQ if RSRQ measurement results are available, otherwise using SINR;
3> for each neighbour cell included:
4> include the optional fields that are available.
NOTE 1: The measured quantities are filtered by the L3 filter as configured in the mobility measurement configuration. The measurements are based on the time domain measurement resource restriction, if configured. Exclude-listed cells are not required to be reported.
NOTE 2: Field measResultSCG-Failure is used to report available results for NR frequencies the UE (102) is configured to measure by SCG RRC signalling.
1> if available, set the locationInfo as in 5.3.3.7.
1> if the UE (102) supports SCG failure for mobility robustness optimization:
2> if the failureType is set to synchReconfigFailureSCG; or
2> if the failureType is set to randomAccessProblem and the SCG failure was declared while T304 was running:
3> set perRAInfoList to indicate the performed random access procedure related information as specified in 5.7.10.5.
3> set the failedPSCellId to the physical cell identity and carrier frequency of the target PSCell of the failed PSCell change;
3> set the previousPSCellId to the physical cell identity and carrier frequency of the source PSCell associated to the last received RRCReconfiguration message including reconfigurationWithSync or cell switch command for the SCG;
3> set the timeSCGFailure to the elapsed time since reception of the last RRCReconfiguration message including the reconfigurationWithSync for the SCG or cell switch command until declaring the SCG failure;
2> else:
3> set the failedPSCellId to the physical cell identity and carrier frequency of the PSCell in which the SCG failure was declared;
3> if the last RRCReconfiguration message including the reconfigurationWithSync for the SCG was received to enter the PSCell or cell switch command in which the SCG failure was declared:
4> set the timeSCGFailure to the elapsed time since reception of the last RRCReconfiguration message including the reconfigurationWithSync or cell switch command for the SCG until declaring the SCG failure;
4> set the previousPSCellId to the physical cell identity and carrier frequency of the source PSCell associated to the last received RRCReconfiguration message including reconfigurationWithSync or cell switch command for the SCG;

The UE (102) shall submit the SCGFailureInformation message to lower layers for transmission.

In an embodiment herein, the UE (102) includes LTM measurement results within SCGFailureInformation message. In an embodiment herein, the UE (102) includes LTM measurement results within SCGFailureInformation message for those candidate cells for which L3 measurements are not available.

In an embodiment herein, the LTM measurement results included in SCGFailureInformation are ordered with sorting based on SS/PBCH block if SS/PBCH block measurement results are available and otherwise based on CST-RS. In an embodiment herein, the LTM measurement results included in SCGFailureInformation are ordered with sorting using RSRP if RSRP measurement results are available, otherwise using RSRQ if RSRQ measurement results are available, otherwise using SINR.

In an embodiment herein, the LTM measurement results included in SHR or SPR are ordered with sorting based on SS/PBCH block if SS/PBCH block measurement results are available and otherwise based on CSI-RS. In an embodiment herein, the LTM measurement results included in SHR or SPR are ordered with sorting using RSRP if RSRP measurement results are available, otherwise using RSRQ if RSRQ measurement results are available, otherwise using SINR.

In an embodiment herein, the UE (102) includes the cell identifiers of LTM candidate cells in SCGFailureInformation even when there are no MeasObjectNR configured on NR SCG for which a measId is configured corresponding to those LTM candidate cells.

In an embodiment herein, the UE (102) includes the cell identifiers of LTM candidate cells in SCGFailureInformation even when they are excluding listed (for e.g., included in excludedCells when it is present or not included in allowedCells when it is present) for L3 measurements.

In an embodiment herein, a NR UE (102) includes the LTM measurements even when they are exclude listed for L3 measurements.

The embodiments disclosed herein can be implemented through at least one software program running on at least one hardware device and performing network apparatus (108) management functions to control the elements. The elements can be at least one of a hardware device, or a combination of hardware device and software module.

The embodiments disclosed herein can be implemented through at least one software program running on at least one hardware device and performing network management functions to control the network elements. The network elements shown in FIG. X include blocks which can be at least one of a hardware device, or a combination of hardware device and software module.

The embodiment disclosed herein describes systems and methods for managing mobility in a wireless network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method for managing mobility by a user equipment (UE) in a wireless network, comprising:
identifying whether the UE is configured with configuration to report successful primary secondary cell group (SCG) cell (PSCell) change or addition information to a network, when performing a PSCell change; and
in case that the UE is configured with the configuration to report the successful PSCell change or addition information to the network, releasing the configuration to report the successful PSCell change or addition information to the network based on the successful PSCell change.

2. The method of claim 1, further comprising:
in case that the UE is configured with the configuration to report the successful PSCell change or addition information to the network, releasing configuration of a threshold for a ratio in percentage between an elapsed T304 timer and a configured value of T304 timer based on the successful PSCell change.

3. The method of claim 1, further comprising:
transmitting a message including at least one of information indicating capability of the UE to support a lower-layer triggered mobility (LTM) for a master cell group (MCG) and information indicating capability of the UE to support the LTM for a secondary cell group (SCG).

4. The method of claim 1, further comprising:
performing measurement on a deactivated PScell.

5. The method of claim 4, wherein the deactivated PScell is considered as a lower-layer triggered mobility (LTM) candidate cell.

6. A method for managing mobility by a user equipment (UE) in a wireless network, comprising:
identifying an indication by lower layers that a procedure for a lower-layer triggered mobility (LTM) cell switch is triggered;
identifying whether the LTM cell switch is triggered on a master cell group (MCG) or on a secondary cell group (SCG); and
releasing or clearing current dedicated radio configuration associated with a cell group for which the procedure for the LTM cell switch is triggered based on the identified indication and whether the LTM cell switch is on the MCG or on the SCG, wherein releasing or clearing the current dedicated radio configuration comprises:
if the LTM cell switch is triggered on the MCG, releasing or clearing the current dedicated radio configuration associated with the cell group for which the procedure for the LTM cell switch except for first at least one parameter including an MGC cell-radio network temporary identifier (C-RNTI) and access stratum (AS) security configurations associated with a master key.

7. The method of claim 6, wherein releasing or clearing the current dedicated radio configuration further comprises:
if the LTM cell switch is triggered on the SCG, releasing or clearing the current dedicated radio configuration associated with the cell group for which the procedure for the LTM cell switch except for second at least one parameter including AS security configurations associated with a secondary key.

8. The method of claim 6, further comprising:
releasing or clearing current common radio configuration associated with the cell group for which the procedure for the LTM cell switch.

9. The method of claim 6, further comprising:
using default values for timers T310, T311 and constants of N310, N311 associated with the cell group for which the procedure for the LTM cell switch.

10. A user equipment (UE) for managing mobility in a wireless network, the UE comprising:
a transceiver; and
at least one processor coupled with the transceiver and configured to:
identify whether the UE is configured with configuration to report successful primary secondary cell group (SCG) cell (PSCell) change or addition information to a network, when performing a PSCell change; and
in case that the UE is configured with the configuration to report the successful PSCell change or addition information to the network, release the configuration to report the successful PSCell change or addition information to the network based on the successful PSCell change.

11. The UE of claim 10, wherein the at least one processor is further configured to:
in case that the UE is configured with the configuration to report the successful PSCell change or addition information to the network, release configuration of a threshold for a ratio in percentage between an elapsed T304 timer and a configured value of T304 timer based on the successful PSCell change.

12. The UE of claim 10, wherein the at least one processor is further configured to:
transmit a message including at least one of information indicating capability of the UE to support a lower-layer triggered mobility (LTM) for a master cell group (MCG) and information indicating capability of the UE to support the LTM for a secondary cell group (SCG).

13. The UE of claim 10, wherein the at least one processor is further configured to:
perform measurement on a deactivated PScell.

14. The UE of claim 13, wherein the deactivated PScell is considered as a lower-layer triggered mobility (LTM) candidate cell.
